(19) United States
(12) Patent Application Publication
(10) Pub. No.: US 2005/0156949 A1
(43) Pub. Date: Jul. 21, 2005

(54) Method of brightness adjustment for a display device

(75) Inventor: Ching-Mei Tsou, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/989,407

(22) Filed: Nov. 17, 2004

(30) Foreign Application Priority Data
Dec. 24, 2003 (TW) 092136735

(51) Int. Cl. G09G 5/10

(52) U.S. Cl. 345/690

(57) ABSTRACT

A method of brightness adjustment for adjusting a display device is disclosed. The display device includes a light detector to generate a first brightness value and a second brightness value, and then a formula is performed to generate a brightness level value according to the first brightness value and the second brightness value. Therefore, a difference between the brightness level value and a predetermined level value is obtained. If the difference between the brightness level value and the predetermined level value is greater than the threshold value, then the predetermined level value is added by the adjustment value; if the difference between the brightness level value and the predetermined level value is smaller than the negative threshold value, then the predetermined level value is subtracted by the adjustment value.

### BACKGROUND OF THE INVENTION

1. Field of the Invention

The present invention relates to a method of brightness adjustment for a display device, and more particularly, to a method of brightness adjustment for a display device of a computing device.

2. Description of the Related Art

The typical adjusting method for a display device involves performing a manual adjustment by pressing buttons on a control panel of the display device. As shown in FIG. 1, several buttons 6 are disposed on the control panel of a conventional display device 5 (such as an LCD device); a user can press one of the buttons 6 to change display parameters for adjusting the brightness of a displayed image. However, the greater brightness a backlight module of the conventional display device 5 provides, the greater the power consumed by the backlight module, and thus the working time a battery can provide is accordingly decreased and the more uncomfortable the conventional display device 5 provides. Furthermore, when the conventional display device 5 continuously operates under high backlighting conditions, the life of the conventional display device 5 is reduced. When the user increases the brightness of the conventional display device 5 and then moves to a darker environment, the overly-bright image on the conventional display device 5 creates discomfort for the user.

Therefore, it is desirable to provide a method of brightness adjustment for a display device to mitigate and/or obviate the aforementioned problems.

### SUMMARY OF THE INVENTION

To avoid the above-mentioned defects, a method of brightness adjustment for a display device is disclosed. The method of brightness adjustment comprises: (A) generating a first brightness value according to a brightness of the environment of the display device; (B) generating a second brightness value according to the brightness of the environment of the display device; (C) generating a brightness level value according to the first brightness value and the second brightness value; (D) determining whether a difference between the brightness level value and a predetermined level value is larger than a threshold value, if it is not, then performing the step (A); (E) adjusting the predetermined level value according to an adjustment value corresponding to the brightness level value and then replacing the predetermined level value; and (F) adjusting the brightness of the display device according to the predetermined level value. The display device can be an LCD or a part of a tablet computer, a notebook computer or a television, and the first brightness value and the second brightness value are obtained by a detector from an infrared light or a visible light.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a prior art display device;

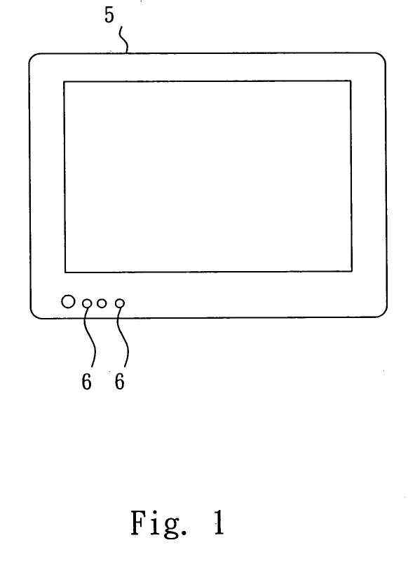

FIG. 2 is a schematic drawing of a display device according to the present invention; and

FIG. 3 is a flowchart of a method of brightness adjustment for a display device according to the present invention.

### DETAILED DESCRIPTION OF THE PREFERRED EMBODIMENT

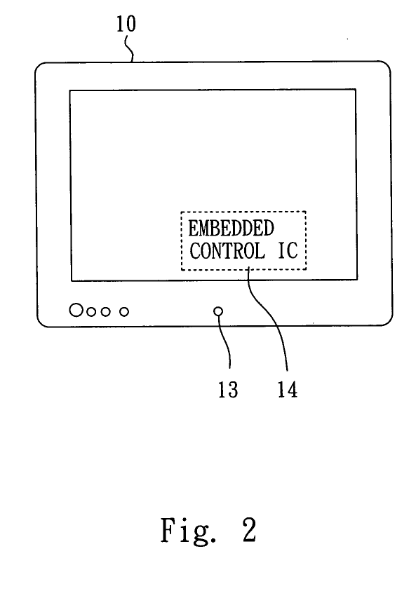

As shown in FIG. 2, a display device 10 according to the present invention is embedded with a control chip 14 and a light detector 13. The light detector 13 is adapted to detect the current brightness of the environment of the display device 10, and works with the control chip 14 to adjust a suitable brightness level for an image displayed on the display device 10. Consequently, in a brighter environment, the brightness of the display device 10 of the present invention automatically switches to a higher brightness level for a displayed image; whereas, in a darker environment, the brightness of the display device 10 of the present invention automatically switches to a lower brightness level for a displayed image. As a result, the user does not suffer discomfort arising from an overly bright or overly dark displayed image.

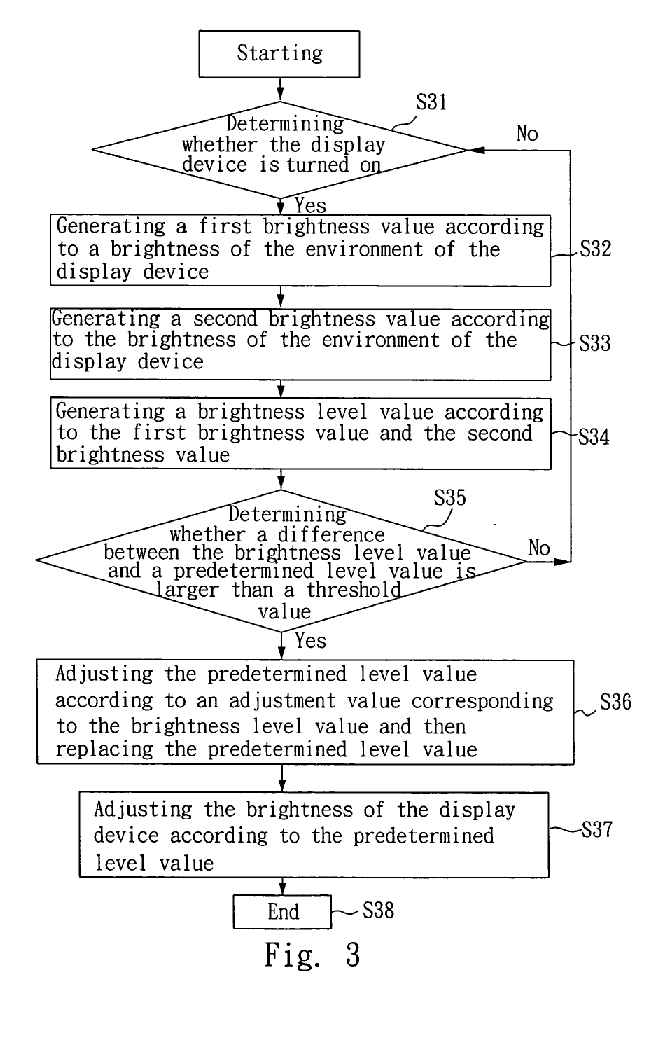

Please refer to FIG. 3. A flowchart discloses a method of brightness adjustment according to the present invention for adjusting the brightness of the display device 10 of the present invention. The method of brightness adjustment of the present invention comprises the following steps: determining whether the display device of the present invention is turned on (step S31); if it is, the light detector 13 generates a first brightness value (step S32) and a second brightness value (step S33). The first brightness value is detected from an infrared light of the current environment of the display device 10 by the light detector 13, and the second brightness value is detected from a visible light and the infrared light of the current environment of the display device 10 by the light detector 13. By inputting the two brightness values into a transformation formula, a brightness level value can be obtained (step S34). The transformation formula is as follows:
R=first brightness value/second brightness value (1)
brightness level value=second brightness value *0.46*e^{3.13R} (2)
However, other transformation formulas are possible based on the demand of the user. An A/D conversion is adapted to perform the conversion of the infrared light or the visible light to obtain the brightness values. The range of the brightness level value is from 0 to 255, wherein 0 is the lowest brightness setting of the display device 10, and 255 is the highest brightness setting of the display device 10. Alternatively, the range of the brightness level value can be determined according to a user's needs. Next, the brightness level value is compared with a predetermined level value to determine whether a difference between the brightness level value and a predetermined level value exceeds a threshold value (step S35). The predetermined level value is corresponding to the current brightness value of the display device 10. If the difference between the brightness level value and a predetermined level value does not exceed the threshold value, then this indicates that the variance of the brightness is within an acceptable range for the user so that the brightness level of the display device 10 does not need to be changed. If the difference between the brightness level value and a predetermined level value exceeds the threshold value, then this indicates that the brightness change around the display device 10 of the present invention is too large. In step S36, the predetermined level value is adjusted based on an adjustment value related with the brightness level value, and then the adjusted predetermined level value replaces the predetermined level value. Finally, the brightness level of the display device 10 is adjusted according to the adjusted predetermined level value (step S37), and the procedure of the method of brightness adjusting of the present invention ends (step S38).

The adjustment value relates with the brightness level value. For example, the range of the brightness level value is divided into four sections; 0˜60 lies within a first section, and has a corresponding adjustment value of one; 61˜125 lies within a second section, and has a corresponding adjustment value of two; 126˜216 lies within a third section, and has a corresponding adjustment value of three; and 217˜255 lies in a fourth section, with a corresponding adjustment value of four. When the brightness level value is 100 (which is within the second section), it will be increased by two or be decreased by two once for adjusting the predetermined level value. Accordingly, the brightness of the display device 10 is adjusted smoothly to a better brightness value. If the brightness level value exceeds the predetermined level value, the adjustment increases the brightness of the displayed image; if the brightness level value is less than the predetermined level value, the adjustment decreases the brightness of the displayed image. The threshold value is adapted to determine whether or not the display device 10 needs to be adjusted, and can be five, ten or fifteen. In this embodiment, five is the preferable choice. For example, when the brightness level value is one hundred and the predetermined level value is one hundred and four, the difference between the two values is less than five, and so the display device 10 of the present invention does not need to be adjusted. When the brightness level value is ninety-five, and the predetermined value is one hundred and four, since the difference is now larger than five, an adjustment is performed on the display device 10 of the present invention which subtracts 2 from the predetermined level value and stores this new predetermined value (which is one hundred and two). When the brightness level value is one hundred and ten and the predetermined level value is one hundred and four, since the difference exceeds five, an adjustment is performed to the display device 10 of the present invention that increases by two the predetermined level value, and stores this new predetermined level value (which is one hundred and six).

Accordingly, the present invention utilizes the light detector 13 to detect background lighting changes around the display device 10 of the present invention, and adjusts the brightness of the display device 10 according to current background lighting conditions so that the brightness of the display device 10 of the present invention changes smoothly in a manner that is comfortable for the user. The display device 10 of the present invention can be an LCD or a part of a tablet computer, a notebook computer or a television.

Although the present invention has been explained in relation to its preferred embodiment, it is to be understood that many other possible modifications and variations can be made without departing from the spirit and scope of the invention as hereinafter claimed.

1. A method of brightness adjustment for a display device comprising:
(A) generating a first brightness value according to a brightness of the environment of the display device;
(B) generating a second brightness value according to the brightness of the environment of the display device;
(C) generating a brightness level value according to the first brightness value and the second brightness value;
(D) determining whether a difference between the brightness level value and a predetermined level value is larger than a threshold value, if it is not, then performing the step (A);
(E) adjusting the predetermined level value according to an adjustment value corresponding to the brightness level value and then replacing the predetermined level value; and
(F) adjusting the brightness of the display device according to the predetermined level value.

2. The method of brightness adjustment as claimed in claim 1, wherein the display device is an LCD.

3. The method of brightness adjustment as claimed in claim 1, wherein the display device is a part of a tablet computer.

4. The method of brightness adjustment as claimed in claim 1, wherein the display device is a part of a notebook computer.

5. The method as claimed in claim 1, wherein a light detector is adapted to generate the first brightness value and the second brightness value and mounted on the surface of the display device.

6. The method as claimed in claim 1, wherein the first brightness value is obtained from an infrared light value.

7. The method as claimed in claim 1, wherein the second brightness value is obtained from a visible light value and an infrared light value.

8. The method as claimed in claim 1, wherein step (E) further comprises: if the difference between the brightness level value and the predetermined level value is greater than the threshold value, then the predetermined level value is added by the adjustment value.

9. The method as claimed in claim 8, wherein a range of the brightness level value is divided into at least one section, and each section corresponds to an adjustment value.

10. The method as claimed in claim 9, wherein the range of the brightness level value is from 0 to 255.

11. The method as claimed in claim 9, wherein the at least one section comprises four portions with corresponding adjustment values of 1, 2, 3, and 4 respectively.

12. The method as claimed in claim 1, wherein step (E) further comprises: if the difference between the brightness level value and the predetermined level value is smaller than the negative threshold value, then the predetermined level value is subtracted by the adjustment value.

13. The method as claimed in claim 12, wherein a range of the brightness level value is divided into at least one section, and the at least one section corresponds to an adjustment value.

14. The method as claimed in claim 11, wherein the range of the brightness level value is from 0 to 255.

15. The method as claimed in claim 11, wherein the at least one section comprises four portions with corresponding adjustment values of 1, 2, 3, and 4 respectively.
